(19) United States
(12) Patent Application Publication
(10) Pub. No.: US 2021/0016867 A1
(43) Pub. Date: Jan. 21, 2021

(54) LIGHTER-THAN-AIR LEAKAGE REDUCTION

(71) Applicant: SKYCOM CORPORATION, Austin, TX (US)

(72) Inventor: Max G. MICHAELIS, IV, Austin, TX (US)

(73) Assignee: SKYCOM CORPORATION, Austin, TX (US)

(21) Appl. No.: 16/978,511

(22) PCT Filed: Mar. 6, 2019
(86) PCT No.: PCT/US19/20906

§ 371 Date: Oct. 1, 2020

Related U.S. Application Data
(60) Provisional application No. 62/639,695, filed on Mar. 7, 2018.

(51) Int. Cl. B64B 1/60; B64B 1/62; B64B 1/44

(52) U.S. Cl. CPC B64B 1/60; B64B 1/44; B64B 1/62

(57) ABSTRACT

An aircraft apparatus may include an outer membrane and an inner flexible bladder. The flexible bladder may include a lighter-than-air lifting gas therein, and an interstitial space between the outer membrane and the inner flexible bladder may include air. Various techniques are disclosed for preventing or reducing physical contact between the outer membrane and the inner flexible bladder, reducing an amount of leakage of the lighter-than-air lifting gas.

### CROSS-REFERENCE TO RELATED APPLICATION

This application is a national phase entry of PCT Application No. PCT/US2019/20906, filed Mar. 6, 2019, which claims priority to U.S. Provisional Patent Application No. 62/639,695, filed Mar. 7, 2018, both of which are incorporated by reference herein in their entireties. This application is also related to application Ser. No. 14/971,651, filed Dec. 16, 2015, (now U.S. Pat. No. 10,367,447, issued Jul. 30, 2019), which is also incorporated by reference herein in its entirety.

### TECHNICAL FIELD

This disclosure relates to lighter-than-air platforms. In particular, this disclosure has applications in the field of unmanned lighter-than-air platforms that can be used for various purposes, such as supporting telecommunications equipment, deploying aerial scientific equipment, etc. In various embodiments, such lighter-than-air platforms may be realized as drones, balloons, airships, or any other suitable implementation, and they may also be referred to as high altitude platform stations (HAPS) or high-altitude lighter-than-air platforms (HALTAPs). For purposes of this disclosure, the general term “aircraft” should be understood as encompassing all such variations.

In some embodiments, aircraft according to this disclosure may include an outer membrane, as well as an inner bladder containing lighter-than-air gas and disposed within the outer membrane. As discussed below, direct contact between the flexible bladder and the outer membrane may be undesirable. Thus this disclosure provides various embodiments for reducing or eliminating such contact.

### SUMMARY

In accordance with the teachings of the present disclosure, the disadvantages and problems associated with existing approaches to aircraft design may be reduced or eliminated.

In accordance with embodiments of the present disclosure, an aircraft apparatus may include an outer membrane and a flexible bladder within the outer membrane. The aircraft apparatus may be operable to float at a selected altitude when a selected quantity of lighter-than-air gas is placed in the flexible bladder. Further, when the selected quantity of lighter-than-air gas is placed in the flexible bladder, the flexible bladder may be configured not to contact the outer membrane.

In accordance with these and other embodiments, an aircraft apparatus may include an outer membrane; a plurality of tendons disposed along a surface of the outer membrane such that a plurality of bulbous gores are defined by the outer membrane; and a flexible bladder within the outer membrane, wherein the flexible bladder is dimensioned such that, when a selected quantity of lighter-than-air gas is placed in the flexible bladder, the flexible bladder is configured to contact the outer membrane along at least some of the plurality of tendons, and such that the flexible bladder is configured to extend partially but not entirely into at least one of the bulbous gores. The aircraft apparatus may further be operable to float at a selected altitude based on the selected quantity of lighter-than-air gas in the flexible bladder.

In accordance with these and other embodiments of the present disclosure, an aircraft apparatus may include an outer membrane; a flexible bladder within the outer membrane; and a separation material within the outer membrane and disposed between at least a first portion of the outer membrane and at least a second portion of the flexible bladder, wherein the solid separation material is configured to prevent physical contact between the first portion and the second portion. The aircraft apparatus may be operable to float at a selected altitude based on a quantity of lighter-than-air gas in the flexible bladder.

In accordance with these and other embodiments of the present disclosure, an aircraft apparatus may include an outer membrane; a flexible bladder within the outer membrane; and a plurality of tension members secured to the outer membrane and the flexible bladder, wherein the plurality of tension members are configured to pull a portion of the flexible bladder towards a portion of the outer membrane such that another portion of the flexible bladder is pulled away from a corresponding another portion of the outer membrane. The aircraft apparatus may be operable to float at a selected altitude based on a quantity of lighter-than-air gas in the flexible bladder.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A illustrates a side view of an aircraft, in accordance with embodiments of the present disclosure;

FIG. 1B illustrates a side section view of the embodiment of FIG. 1A;

FIG. 1C illustrates a top section view of the embodiment of FIGS. 1A and 1B;

FIG. 2 illustrates a side section view of another aircraft, in accordance with embodiments of the present disclosure;

FIG. 3 illustrates a side section view of another aircraft, in accordance with embodiments of the present disclosure; and

FIG. 4 illustrates a side section view of another aircraft, in accordance with embodiments of the present disclosure.

### DETAILED DESCRIPTION

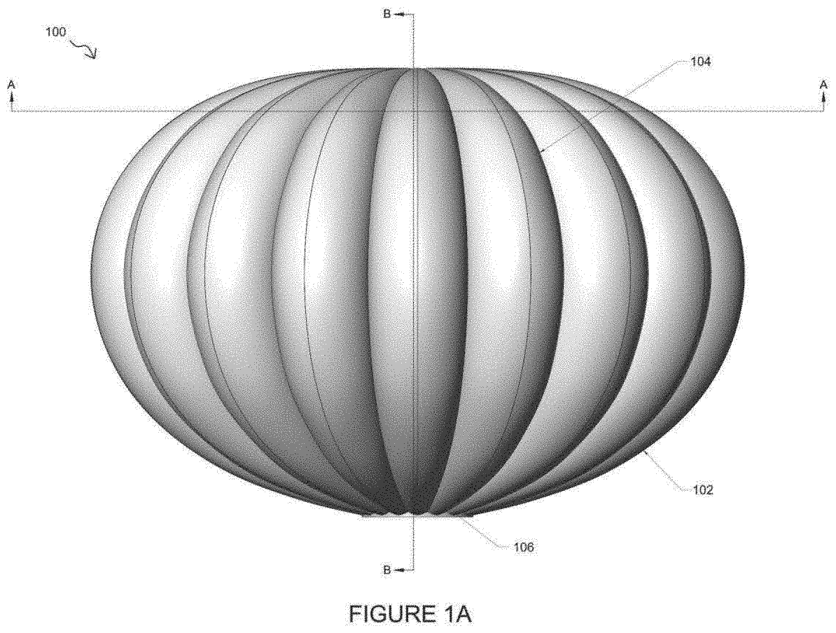

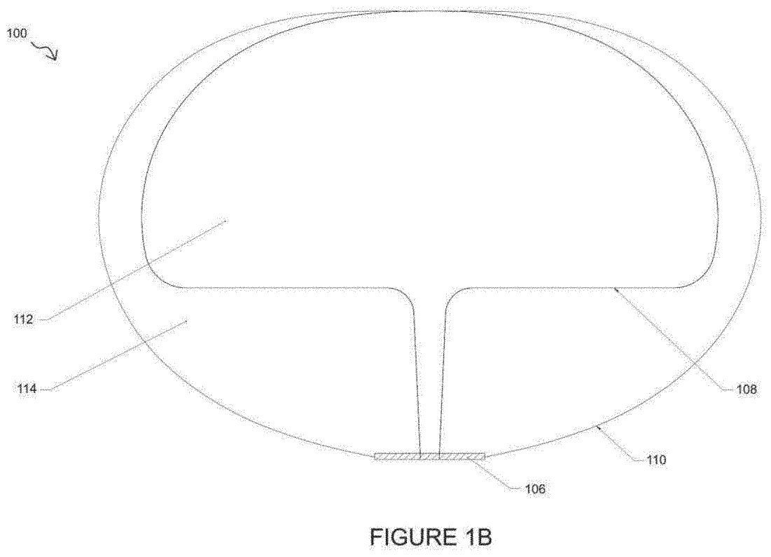

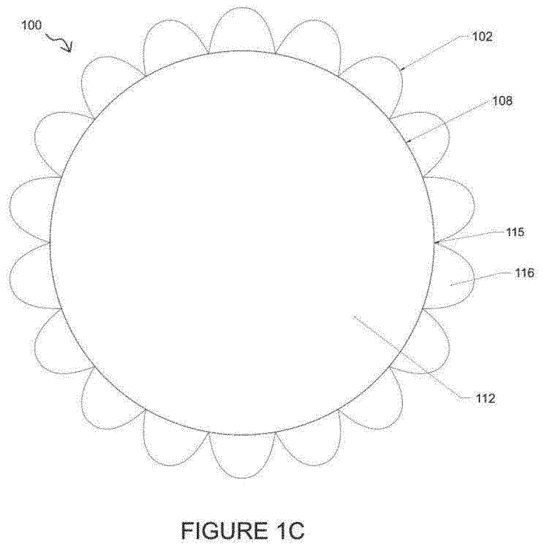

Preferred embodiments and their advantages are best understood by reference to FIGS. 1A through 4, wherein like numbers are used to indicate like and corresponding parts.

According to some embodiments, an aircraft may include a flexible bladder disposed within an outer membrane. The flexible bladder may be filled with lighter-than-air gas, such as hydrogen or helium (also referred to as “lifting gas”). Pressure control circuitry may be configured to equalize a pressure between an interior of the flexible bladder and a region disposed between the flexible bladder and the outer membrane (an “interstitial space”). As a result, leakage of lighter-than-air gas from the bladder to the interstitial space and/or the atmosphere surrounding the outer membrane may be reduced, as compared to a system in which the pressure in the interstitial space is lower than the pressure inside the flexible bladder.

During normal flight, the outer membrane may be filled to its maximum volume, and its internal pressure may be higher than that of the surrounding atmosphere, but because the control system is configured to equalize the pressure between the interior of the flexible bladder and the interstitial space, it may be desirable to monitor the volume of the flexible bladder; by doing so, the control system can increase the pressure in the interstitial space to prevent the flexible bladder from reaching its maximum volume and becoming pressurized relative to the interstitial space. For example, the control system may pump air into the interstitial space to decrease the volume of the flexible bladder (or release air from the interstitial space to increase the volume of the flexible bladder) in order to maintain the pressure in the interstitial space at an equal level with the pressure inside the flexible bladder. Therefore, according to some embodiments, the flexible bladder and the interface between the flexible bladder and the outer membrane may be configured to accommodate a range of volumes less than its maximum volume.

Embodiments of the present disclosure may be particularly useful at higher altitudes (e.g., above 60,000 feet pressure altitude). For operation at lower altitudes, existing airship envelopes and ballonets are typically constructed out of robust materials which resists abrasion and can withstand high pressure differentials without leaking.

Without wishing to be limited by theory, it is believed that the primary leak path for such existing airships is typically the molecular diffusion of the lighter-than-air gas through the material, as opposed to leakage through material defects, seams, or other imperfections and microscopic holes in the envelope, which may occur based on the overall pressure differential. Instead, molecular diffusion may be dependent upon partial pressure differential, not overall pressure differential.

For high altitude operations, it may be advantageous to use thin, lightweight materials to reduce weight. The method of equalizing the pressure between the inner bladder and interstitial space may drastically reduce the leakage of lifting gas that would otherwise result from overall pressure differentials across such lightweight materials; however, because the partial pressure of the lifting gas is still higher inside the bladder than it is in the interstitial space, molecular diffusion, although greatly reduced at the low temperatures typically found at higher altitudes, may be a primary source of leakage. Accordingly, the teachings of this disclosure are primarily applicable to high-altitude embodiments, where material defects, seams, imperfections, and microscopic holes are considered more of a concern than molecular diffusion.

According to some embodiments, a control system may maintain an equal pressure between the flexible inner bladder and the interstitial space. However, if and when the inner bladder reaches its maximum volume, its pressure may begin to increase relative to the interstitial space. Therefore, in order for a control system to achieve its goal of maintaining equal pressure, it may monitor the volume and increase the pressure of the interstitial space as needed to prevent the flexible bladder from reaching its maximum volume. A control system may also monitor the pressure differential directly and use that data to maintain or restore equilibrium.

Because the outer envelope may be kept at a higher pressure than the surrounding atmosphere, it can provide a stable, unmovable platform for a device configured to measure the volume of the flexible bladder. Alternatively or in addition, a volume measuring device may be mounted on the frame of a semi-rigid airship, or on another rigid component such as a rigid core or load ring.

In this context, and particularly in cases where an atmospheric pressure is lower than a pressure of the lighter-than-air gas in the flexible bladder, direct contact between the flexible bladder and the outer membrane may result in a leakage path from the inner bladder to the exterior of the outer membrane. Placing a flexible bladder containing a lighter-than-air gas within an outer membrane containing a heavier gas than the lighter-than-air gas (e.g., air) may result in the bladder floating to the top of the outer membrane and making direct contact with its inner surface. As a result, a leakage path may be created. Several embodiments are discussed herein that may reduce or eliminate direct contact between the flexible bladder and the outer membrane.

As described herein, various terms are used interchangeably to describe the flexible bladder and the outer membrane, respectively. For example, in some cases, the flexible bladder may be referred to as an “inner envelope,” an “inner bladder,” or an “inner membrane.” The outer membrane may be referred to as an “outer envelope” or an “outer bladder.”

Further, for purposes of this disclosure, when two or more elements are referred to as “coupled” to one another, such term indicates that such two or more elements are in electronic communication or mechanical communication, as applicable, whether connected directly or indirectly, with or without intervening elements. When two or more elements are referred to as “coupleable” to one another, such term indicates that they are capable of being coupled together.

Although the aircraft depicted in the drawings of this disclosure are shown as having a generally spherical shape, other shapes are contemplated, including a blimp shape (e.g., elongated) and a lenticular shape.

Turning now to FIG. 1A, an embodiment is shown in which aircraft 100 using bulbous gores 102 is shown. Tendons 104 (also referred to as “load tapes”) may be affixed to the outer membrane (e.g., affixed to an interior or an exterior of the outer membrane) or surrounding the outer membrane and may be used to define bulbous gores 102 in the outer membrane. Bulbous gores 102 may distribute and lower stress in a material of the outer membrane. For example, in some embodiments, the majority of the tensile load may be carried in high-strength tendons 104 that run from a load-bearing crown ring at the top of the aircraft (not shown) to a load-bearing load ring 106 at the bottom of the aircraft (also referred to as a “load plate”). The membrane material between tendons 104 may be cut to an excess length in such a way that bulbous gores 102 are defined, as shown. Gores 102 may result in a low local radius in the material, which may allow for a higher pressure in the aircraft than could otherwise be achieved.

In other embodiments, aircraft 100 may be constructed from a plurality of separate sections bounded by and joined at tendons 104. In such embodiments as well, bulbous gores 102 may be formed.

Bulbous gores 102 may be used to reduce direct contact between the outer membrane and the flexible bladder. As discussed below, the flexible bladder may be dimensioned to have a smaller surface area than the outer membrane to reduce direct contact between the flexible bladder and the outer membrane. In particular, the flexible bladder may be dimensioned such that the flexible bladder extends partially but not entirely into bulbous gores 102, resting instead along tendons 104. In other embodiments, the flexible bladder may be attached to the points of contact 115 as illustrated in FIG. 1C and pulled taut such that the flexible bladder does not extend into the bulbous gores. Cross sections of aircraft 100 may be seen in FIGS. 1B and 1C, which respectively show a side section view along plane B and a top section view along plane A.

In FIG. 1B, inner envelope 108 may be seen inside outer envelope 110. Inner envelope 108 is filled with lifting gas 112, and the interstitial space between envelopes is filled with air 114 in this embodiment.

In FIG. 1C, it may be seen that inner envelope 108 contacts outer envelope 110 at contact points 115, which run along tendons 104. Inner envelope 108 may extend partially, but not fully, into region 116 of gores 102.

In some embodiments, inner envelope 108 may be directly coupled to outer envelope 110 at some or all of the points of contact. This connection may be established by welding the materials together, using a fastener (e.g., sewing the materials together or using a fastener such as a clip), using an adhesive (e.g., tape or glue), or by any other suitable means. As a result of fastening inner envelope 108 to outer envelope 110, in some cases, misalignment of inner envelope 108 (e.g., during inflation or as a result of movement of the aircraft) may be prevented.

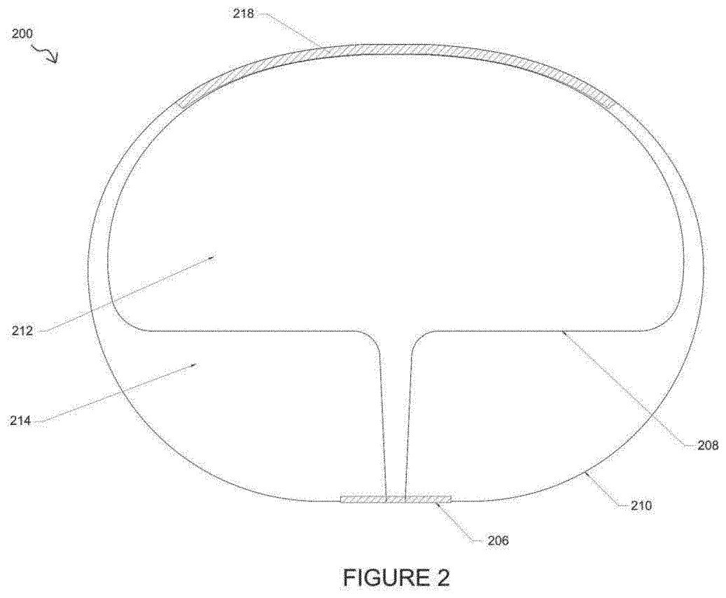

Turning now to FIG. 2, another embodiment is shown as aircraft 200. (In FIGS. 2-4, some reference numerals correspond to the reference numerals in FIGS. 1A-1C and may not be explicitly discussed as separate elements. For example, lifting gas 212 corresponds to lifting gas 112, etc.)

In some embodiments, inner envelope 208 may naturally attempt to conform to outer envelope 210. For example, inner envelope 208 may conform to the top of outer envelope 210 as a result of an interior of inner envelope 208 having a lifting gas therein, and thus having a higher lift than the interstitial space. In various embodiments, a solid separation material 218 such as a porous foam, sponge-like material, or mesh which prevents direct contact between the inner and outer envelopes, but which allows gas to move freely through it may be placed between inner envelope 208 and outer envelope 210. Separation material 218 may allow force to be transferred from inner envelope 208 to outer envelope 210 without the envelopes touching each other directly, insulating the surface of inner envelope 208 from the surface of outer envelope 210. In some embodiments, separation material 218 may be a porous material. A pressure within the pores of such a porous material may be equal to a pressure within the interstitial space, which may, in some cases, have a zero pressure differential with the pressure within the flexible bladder.

Additionally, the porous material may be lighter, as compared to a similarly dimensioned layer of such material except without pores. Further, the porous material may more efficiently transfer pressure, as compared to a separation material without pores.

Although FIG. 2 illustrates the separation material as being present only above inner envelope 208, in other embodiments, the separation material may be present in additional or different locations (e.g., around a middle of inner envelope 208, completely surrounding inner envelope 208, sized and dimensioned to prevent any contact between the envelopes, etc.).

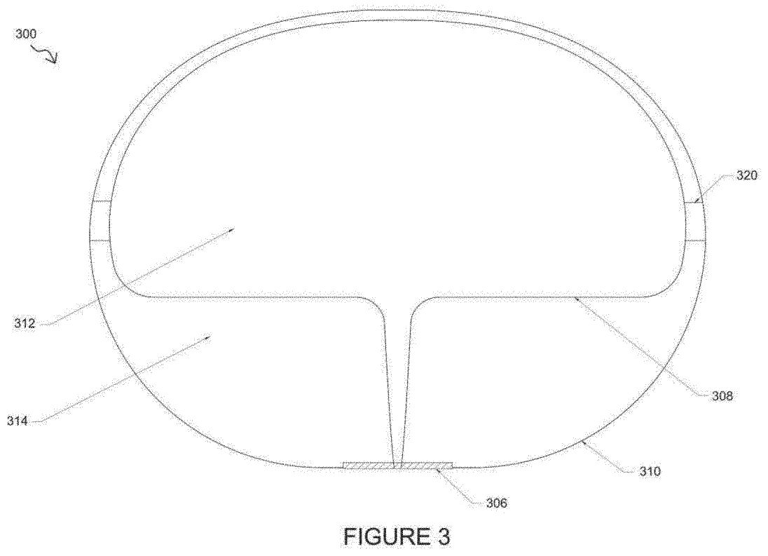

Turning now to FIG. 3, another embodiment is shown as aircraft 300 including tension members 320. In various embodiments, tension members 320 coupling inner envelope 308 to outer envelope 310 may maintain a separation from outer envelope 310. Tension members 320 may couple the two envelopes and be oriented in such a way as to prevent a portion of inner envelope 308 from contacting a corresponding portion of outer envelope 310. Tension members 320 may prevent contact by supplying horizontal tension, vertical tension, or both. In the embodiment shown in FIG. 3, tension members 320 are oriented substantially horizontally, extending radially outward from a central vertical axis of aircraft 300.

For example, tension members 320 coupled to an equator of inner envelope 308 and an equator of outer envelope 310 (e.g., spaced around the circumference of such equator) may cause inner envelope 308 to be stretched along its equator, causing a top surface of inner envelope 308 to be pulled downward sufficiently to avoid contact with a top surface of outer envelope 310.

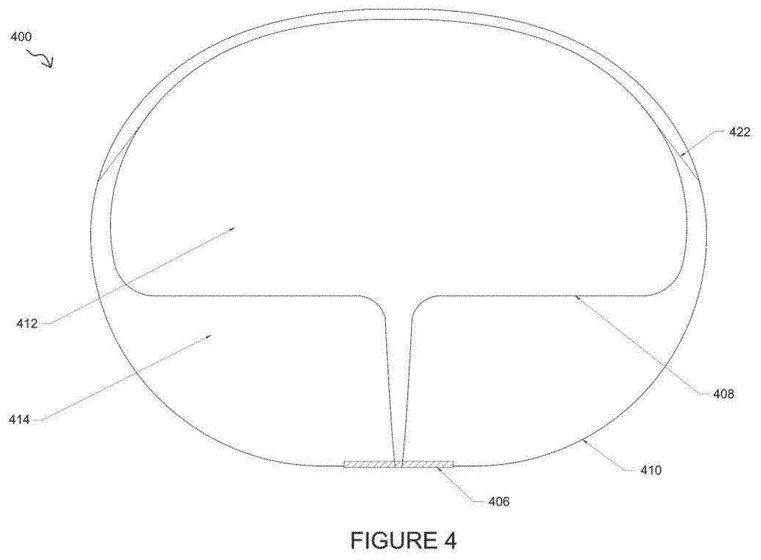

Turning now to FIG. 4, another embodiment is shown as aircraft 400, which includes tension members 422 applying tension in a more vertical direction. By supplying vertical tension, tension members 422 may directly pull inner envelope 408 away from the top surface of outer envelope 410. As a result, tension members 422 may effectively transmit the lifting load of lifting gas 412 through the tension member(s) to outer envelope 410 at the connection point(s). As one of ordinary skill in the art with the benefit of this disclosure, tension members 422 may be attached in any suitable location (e.g., at the bottom of inner envelope 408).

In some embodiments, the tension members can include a “net” or continuous membrane that may isolate the flexible bladder from the outer membrane, effectively dividing the interstitial space but allowing pressure equalization between the interstitial space and the flexible bladder.

Although the use of bulbous gores, separation material, and tension members are described herein separately, in various embodiments, such features may be used in conjunction with one another in any combination. In some embodiments, a combination of such features may result in reduced requirements for various ones of such features. For example, if a separation material and horizontal tension members are included together, in some embodiments, the horizontal tension members may have a reduced amount of tension (e.g., because the separation material prevents a portion of the flexible bladder from directly contacting the outer membrane).

In some embodiments, the flexible bladder may be dimensioned in a way so as to reduce a likelihood that the flexible bladder directly contacts the outer membrane. For example, in various embodiments, the flexible bladder may be dimensioned such that less than twenty percent of the surface area of the flexible bladder contacts a surface of the outer membrane when the flexible bladder is at least fifty percent full of lighter-than-air gas. In other embodiments, these percentages may vary. For example, in some embodiments, the flexible bladder may be dimensioned such that less than one percent of the surface area of the flexible bladder contacts a surface of the outer membrane when the flexible bladder is at least eighty percent full of lighter-than air gas. In some embodiments, the separation material or the net may surround the flexible bladder such that the flexible bladder does not contact the outer membrane.

Various specific embodiments have been described in detail above. Such embodiments may solve some, all, or even none of the problems discussed with reference to existing systems. This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An aircraft apparatus comprising:
an outer membrane; and
a flexible bladder within the outer membrane;
wherein the aircraft apparatus is operable to float at a selected altitude when a selected quantity of lighter-than-air gas is placed in the flexible bladder; and
wherein, when the selected quantity of lighter-than-air gas is placed in the flexible bladder, the flexible bladder is configured not to contact the outer membrane.

2. An aircraft apparatus comprising:
an outer membrane;
a plurality of tendons disposed along a surface of the outer membrane such that a plurality of bulbous gores are defined by the outer membrane; and
a flexible bladder within the outer membrane, wherein the flexible bladder is dimensioned such that, when a selected quantity of lighter-than-air gas is placed in the flexible bladder, the flexible bladder is configured to contact the outer membrane along at least some of the plurality of tendons, and such that the flexible bladder is configured to extend partially but not entirely into at least one of the bulbous gores;
wherein the aircraft apparatus is operable to float at a selected altitude based on the selected quantity of lighter-than-air gas in the flexible bladder.

3. The aircraft apparatus of claim 2, further comprising:
pressure control circuitry configured to maintain the flexible bladder at an inflation level less than a maximum inflation level of the flexible bladder.

4. The aircraft apparatus of claim 3, wherein an interstitial space disposed outside the flexible bladder and inside the outer membrane is filled with air.

5. The aircraft apparatus of claim 4, wherein a pressure of the lighter-than-air gas inside the flexible bladder is equal to a pressure of air in the interstitial space.

6. The aircraft apparatus of claim 2, wherein the tendons are coupled to a crown ring at a top of the aircraft apparatus.

7. The aircraft apparatus of claim 6, wherein the tendons are coupled to a load ring at a bottom of the aircraft apparatus.

8. An aircraft apparatus comprising:
an outer membrane;
a flexible bladder within the outer membrane; and
a separation material within the outer membrane and disposed between at least a first portion of the outer membrane and at least a second portion of the flexible bladder, wherein the separation material is configured to prevent physical contact between the first portion and the second portion;
wherein the aircraft apparatus is operable to float at a selected altitude based on a quantity of lighter-than-air gas in the flexible bladder.

9. The aircraft apparatus of claim 8, wherein the separation material is porous.

10. The aircraft apparatus of claim 8, wherein the separation material is disposed at a top of the flexible bladder.

11. The aircraft apparatus of claim 8, wherein the separation material is of a size sufficient to prevent any physical contact between the flexible bladder and the outer membrane.

12. An aircraft apparatus, comprising:
an outer membrane;
a flexible bladder within the outer membrane; and
a plurality of tension members secured to the outer membrane and the flexible bladder, wherein the plurality of tension members are configured to pull a portion of the flexible bladder towards a portion of the outer membrane such that another portion of the flexible bladder is pulled away from a corresponding another portion of the outer membrane;
wherein the aircraft apparatus is operable to float at a selected altitude based on a quantity of lighter-than-air gas in the flexible bladder.

13. The aircraft apparatus of claim 12, wherein the plurality of tension members are disposed around a circumference of the flexible bladder.

14. The aircraft apparatus of claim 13, wherein the plurality of tension members are oriented horizontally.

15. The aircraft apparatus of claim 13, wherein the plurality of tension members are oriented radially outward from a central vertical axis of the aircraft apparatus.

16. The aircraft apparatus of claim 13, wherein the plurality of tension members are oriented vertically.

17. The aircraft apparatus of claim 13, wherein the plurality of tension members are oriented at a selected angle between vertical and horizontal.

18. The aircraft apparatus of claim 13, wherein the plurality of tension member comprise a net configured to hold the flexible bladder away from an inner surface of the outer membrane.
